(19) United States
(12) Patent Application Publication
(10) Pub. No.: US 2023/0284182 A1
(43) Pub. Date: Sep. 7, 2023

(54) METHOD AND APPARATUS FOR PAGING

(71) Applicant: LENOVO (BEIJING) LIMITED, BEIJING (CN)

(72) Inventors: JIE SHI, BEIJING (CN); LIANHAI WU, BEIJING (CN); HAIMING WANG, BEIJING (CN); JING HAN, BEIJING (CN); RAN YUE, BEIJING (CN)

(21) Appl. No.: 18/040,654

(22) PCT Filed: Aug. 5, 2020
(86) PCT No.: PCT/CN2020/107149

§ 371 Date: Feb. 6, 2023

(51) Int. Cl. H04W 68/02; H04W 72/232; H04W 72/1273

(52) U.S. Cl. CPC H04W 68/02; H04W 72/232; H04W 72/1273

(57) ABSTRACT

Embodiments of the present application are related to a method and apparatus for paging. An exemplary method of the present application includes: receiving paging grouping information associated with physical downlink control channel (PDCCH), receiving paging group identity (ID) information indicated in PDCCH, and determining whether to decode physical downlink shared channel (PDSCH) based on the paging grouping information and the paging group ID information. Embodiments of the present application can improve the legacy paging mechanism and efficiently reduce unnecessary paging receptions, and accordingly save power.

### TECHNICAL FIELD

Embodiments of the present application generally relate to wireless communication technology, and more specifically relates to grouping user equipment (UE)s for paging.

### BACKGROUND OF THE INVENTION

Wireless communication networks have grown rapidly over the years. The next generation wireless communication system 5G is an example of an emerging telecommunication standard. New radio (NR) is generally a set of enhancements to the long term evolution (LTE) mobile standard promulgated by the 3rd generation partnership project (3GPP). 5G and/or new radio (NR) networks are expected to increase throughput, coverage, and robustness and reduce latency and operational and capital expenditures.

With the development of the 5G system, various aspects need to be studied to perfect the 5G/NR technology. For example, Rel-17 RP-193264 and RP-192673 respectively specify objectives for UE power saving by reducing unnecessary UE paging receptions and enhancing paging indication etc.

However, due to complicated factors in a wireless communication network, how to provide an improved paging mechanism for power saving, which can work well under various conditions should be seriously considered.

### BRIEF SUMMARY OF THE INVENTION

One objective of the embodiments of the present application is to provide a solution for paging.

According to some embodiments of the present application, a method may include: receiving paging grouping information associated with physical downlink control channel (PDCCH), receiving paging group identity (ID) information indicated in PDCCH, and determining whether to decode physical downlink shared channel (PDSCH) based on the paging grouping information and the paging group ID information.

According to another embodiment of the present application, the method may include: transmitting paging grouping information associated with PDCCH; and transmitting paging group ID information indicated in PDCCH, so that whether to decode PDSCH can be determined based on the paging grouping information and the paging group ID information.

In some embodiments of the present application, the paging group ID information is indicated via at least one of the following: at least one paging radio network temporary Identity (P-RNTI) value; time and frequency resource(s) of downlink control information (DCI); and at least one set of DCI bits scrambled by P-RNTI in the PDCCH.

Yet another embodiment of the present application provides an apparatus. The apparatus include a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement a method.

Embodiments of the present application can improve the legacy paging mechanism and efficiently reduce unnecessary paging receptions.

### BRIEF DESCRIPTION OF THE DRAWINGS

In order to describe the manner in which advantages and features of the present application can be obtained, a description of the present application is rendered by reference to specific embodiments thereof which are illustrated in the appended figures. These figures depict only example embodiments of the present application and are not therefore to be considered as limiting of its scope.

FIG. 1 illustrates a schematic diagram of an exemplary wireless communication system according to some embodiments of the present disclosure;

FIG. 2 is a flow chart illustrating a method for paging according to some embodiments of the present application;

FIG. 3 illustrates a scheme diagram of paging grouping by a paging probability information based grouping rule in the DCI bit scheme according to some embodiments of the present application;

FIG. 4 illustrates a scheme diagram of paging grouping by a combination rule of the UE ID based grouping rule with the PP information based grouping rule in the DCI bit scheme according to some embodiments of the present application;

FIG. 5 illustrates a scheme diagram of paging grouping for mobile UEs and non-mobile UEs in the DCI bit scheme according to some embodiments of the present application;

FIG. 6 illustrates a scheme diagram of paging grouping in the R-RNTI scheme according to some embodiments of the present application; and

FIG. 7 illustrates a block diagram of an apparatus for paging according to some embodiments of the present application.

### DETAILED DESCRIPTION OF THE INVENTION

The detailed description of the appended figures is intended as a description of the currently preferred embodiments of the present application, and is not intended to represent the only form in which the present application may be practiced. It should be understood that the same or equivalent functions may be accomplished by different embodiments that are intended to be encompassed within the spirit and scope of the present application.

To facilitate understanding, embodiments of the present application are provided under specific network architecture and service scenarios, such as, 3GPP LTE Rel-15, 3GPP 5G NR, and onwards. Persons skilled in the art are well-aware that, with developments of network architecture and new service scenarios, the embodiments in the present application are also applicable to similar technical problems.

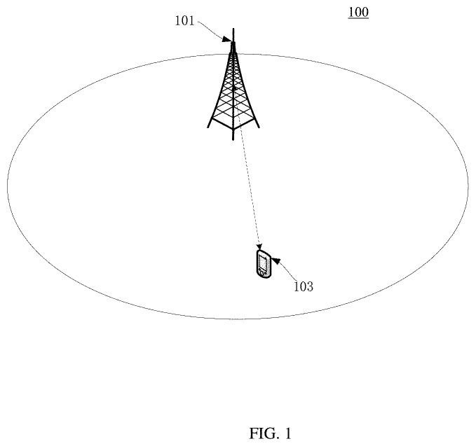

FIG. 1 illustrates a schematic diagram of an exemplary wireless communication system 100 according to some embodiments of the present disclosure.

As shown in FIG. 1, the wireless communication system 100 can include at least one base station (BS) 101 and at least one UE 103. Although a specific number of BSs 101 and UEs 103, e.g., only one BS 101 and one UE 103, are depicted in FIG. 1, one skilled in the art will recognize that any number of BSs 101 and UEs 103 may be included in the wireless communication system 100.

The BS 101 may be distributed over a geographic region, and generally be a part of a radio access network that may include one or more controllers communicably coupled to one or more corresponding BSs 101. In some embodiments of the present disclosure, each BS 101 may also be referred to as an access point, an access terminal, a base, a macro cell, a Node-B, an evolved Node B (eNB), a gNB, a Home Node-B, a relay node, a device, or described using other terminology used in the art.

According to some embodiments of the present disclosure, the UE 103 may be a computing device, such as a desktop computer, a laptop computer, a personal digital assistant (PDA), a tablet computer, a smart television (e.g., a television connected to the Internet), a set-top box, a game console, a security system (including a security camera), a vehicle on-board computer, a network device (e.g., a router, a switch, or a modem), or the like. According to some other embodiments of the present disclosure, the UE 103 may be a portable wireless communication device, a smart phone, a cellular telephone, a flip phone, a device having a subscriber identity module, a personal computer, a selective call receiver, or any other device that is capable of sending and receiving communication signals on a wireless network. According to some other embodiments of the present disclosure, the UE 103 may be a RedCap UE.

In addition, the UE 103 may also be referred to as a subscriber unit, a mobile, a mobile station, a user, a terminal, a mobile terminal, a wireless terminal, a fixed terminal, a subscriber station, a user terminal, or a device, or described using other terminology used in the art.

To reduce wrong paging alarm(s), according to embodiments of the present application, different strategies can be applied to enhance paging indication. For example, physical downlink control channel (PDCCH)-based paging indication can be used to group UEs to. Accordingly, a UE will not decode the physical downlink shared channel (PDSCH) indicated in the PDCCH for paging to check the record identity (ID) list for paging in the PDSCH when there is no its own ID in the record ID list, so that power is saved. Although some UE grouping schemes have been applied in some scenarios or functions, e.g., wake up signal (WUS), however grouping rules in different scenarios or functions are different. For example, how to design grouping rule(s) for paging, and how a group ID is expressed or indicated by parameters associated to PDCCH decoding procedure should also be seriously considered due to factors e.g., compatibility and overhead etc.

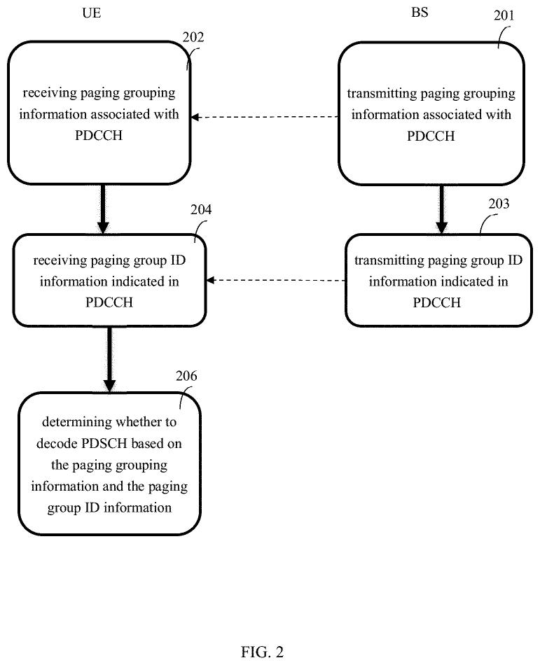

FIG. 2 is a flow chart illustrating a method for paging according to some embodiments of the present application. Although the method is illustrated in a system level by a UE and a BS (e.g., the BS 101 and UE 103 as illustrated and shown in FIG. 1), persons skilled in the art can understand that the method implemented in the UE and that implemented in the BS can be separately implemented and incorporated by other apparatus with the like functions.

Referring to FIG. 2, in the network side, paging grouping information associated with PDCCH may be configured by a BS. The paging grouping information associated with PDCCH may include various information associated with paging grouping, e.g., paging probability information for paging grouping, and DCI bit information for paging grouping etc. In step 201, the paging grouping information associated with PDCCH is transmitted, e.g., by the BS. In step 202, the paging grouping information associated with PDCCH may be received in the UE side.

Paging group ID information may also be configured in the network side. In step 203, paging group ID information indicated in the PDCCH will also be transmitted, so that whether to decode PDSCH can be determined based on the paging grouping information and the paging group ID information. In step 204, the paging group ID information indicated in the PDCCH may be received in the UE side.

According to some embodiments of the present application, the paging group ID information may be indicated in PDCCH via at least one of the following: at least one P-RNTI value, time and frequency resource(s) of DCI, and at least one set of DCI bits scrambled by P-RNTI in the PDCCH.

Based on the received information, such as the paging grouping information and the paging group ID information, whether to decode PDSCH is determined in the UE side in step 206 so that only PDSCH associated with the UE can be decoded to save power of the UE. The paging group ID information may not directly indicate a paging group ID. The UE needs to computes which paging group ID(s) is indicated based on the paging grouping information and the paging group ID information.

In some embodiments of the present application, a reference signal (RS) may be transmitted from the network side to the UE side. The UE can determine whether to decode the PDSCH based on the received RS.

More details on embodiments of the present application will be illustrated in the following text in combination with the appended drawings.

According to some embodiments of the present application, the paging group ID information is indicated via a set of downlink control information (DCI) bits in the PDCCH, which is also referred to as “DCI bit scheme” hereafter. That is, a set of paging group IDs can be mapped into the set of DCI bits. Each set of DCI bits may include one or more DCI bits. In the UE side, a UE may determine whether its paging group ID is indicated in the paging grouping ID information. In response to its paging group ID is not indicated in the paging group ID information, the UE will determine not to decode the PDSCH. In response to the paging group ID is indicated in the paging group ID information, the UE may determine to decode the PDSCH.

According to some embodiments of the present application, there are various paging grouping rules for grouping UEs in DCI bit scheme. For example, a paging group rule may be a single basic rule, e.g., UE ID based grouping rule, or a paging probability (PP) information based grouping rule etc. For example, according to the PP information grouping rule, a set of paging group IDs is mapped into the set of DCI bits based on paging probability based grouping, each bit of the set of DCI bits being associated with a paging group ID. The PP information for grouping and the DCI bits information for paging can be configured in the network side. The paging probability information can be the paging probability, such as a probability value from 0 to 1, or a probability level value from low to high, or a paging frequency, e.g., 100 times per second.

According to some embodiments of the present mapping a set of paging group IDs into the set of DCI bits based on paging probability based grouping includes: determining a corresponding paging probability range associated with each bit of the set of DCI bits, and dividing a plurality of UEs into the at least one paging group based on respective paging probability of the plurality of UEs.

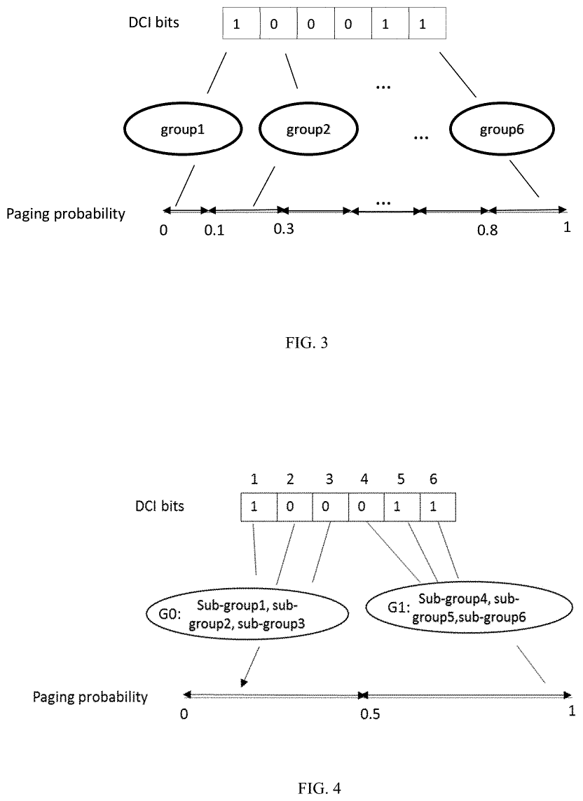

FIG. 3 illustrates a scheme diagram of paging grouping by a paging probability information based grouping rule in the DCI bit scheme according to some embodiments of the present application.

Referring to FIG. 3, there are 6 DCI bits, each DCI being associated with a PP range, e.g., a first DCI bit associated with [0, 0.1] corresponding to group 1, a second DCI bit associated with [0.1, 0.3] corresponding to group 2 . . . and a sixth DCI associated with [0.8, 1] corresponding to group 6 from the left to right. Each UE is grouped into a corresponding paging group based on its own PP. For example, when a UE's PP is 0.2, which is within [0.1, 0.3], the UE will be grouped into group 2. For this UE, when the paging group ID information indicates group 2 (which may need the UE to compute it based on related information), the UE will further decode the PDSCH. Otherwise, the UE will not decode the PDSCH.

According to some other embodiments of the present application, a paging group rule may also be a combination of several basic grouping rules, e.g., a combination of the UE ID based grouping rule with the PP information based grouping rule. An exemplary combination rule of the UE ID based grouping rule with the PP information based grouping rule is the PP information based grouping rule firstly and UE ID based grouping rule secondly, that is mapping a set of paging group IDs into the set of DCI bits based on paging probability based grouping first and then UE ID based grouping.

In some embodiments of the present application, mapping a set of paging group IDs into the set of DCI bits based on paging probability based grouping first and then UE ID based grouping may include: dividing the set of DCI bits into at least one sub-set of DCI bits based on at least one paging probability threshold; associating each sub-set of DCI bits with a corresponding paging probability range determined based on the at least one paging probability threshold; dividing a plurality of UEs into at least one UE group associated with a corresponding paging probability range based on respective paging probability of the plurality of UEs; and dividing UE(s) within each UE group into at least one UE sub-group based on respective UE ID of the UE(s), wherein each UE sub-group corresponds to a paging group.

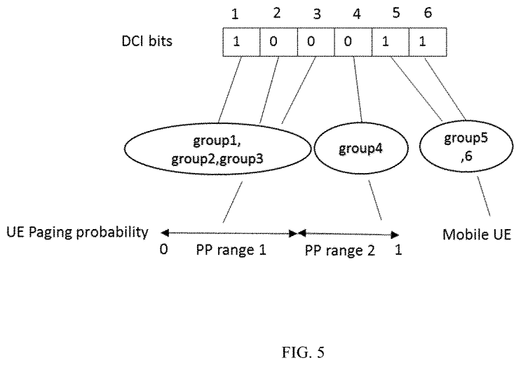

FIG. 4 illustrates a scheme diagram of paging grouping by a combination rule of the UE ID based grouping rule with the PP information based grouping rule in the DCI bit scheme according to some embodiments of the present application.

Referring to FIG. 4, the combination rule of the UE ID based grouping rule with the PP information based grouping rule is the paging probability information based grouping rule firstly and UE ID based grouping rule secondly. For example, there are 6 DCI bits, and they are divided into two sub-sets of DCI bits, each sub-set of DCI bits includes 3 DCI bits. Each sub-set of DCI bits is associated with a paging group a corresponding paging probability range, e.g., a first sub-set of DCI bits including DCI bits 1-3 associated with a first PP range [0, 0.5] and a second sub-set of DCI bits including DCI bits 4-6 associated with a second PP range [0.5, 1]. Then, a plurality of UEs can be grouped in two UE groups respectively corresponding to the two PP ranges. For example, for a UE with PP being 0.2, it will be grouped into a first UE group G0 corresponding to the first PP range. For each UE group, e.g., G0 and G1, the UEs therein will be further grouped into 3 UE sub-groups based on their UE IDs, each UE sub-group associated with a DCI bit of the corresponding sub-set of DCI bits. For example, a function f(UE-ID) mode (the number of UE groups) can be used to group a UE within a UE group into a UE sub-group. The function is similar to

$$wg = floor ( \frac{UE\_ID}{N \times {N}_{s}} ) mod {N}_{w} ,$$

which is used for selecting a group ID from a group set. Here, N, Ns are the paging related parameters configured by the network side, Nw is the number of group in a group set, or the number of sub-group associated to a group. The number of UE groups could be one or more. Details for the function will be omitted accordingly.

In some embodiments of the present application, the network may configure at least one DCI bit for mobile UEs. That is, a set of paging group IDs for mobile UEs can be mapped into a set of DCI bits. The at least one DCI bits can be independently used for mobile UEs or can be shared with UEs with the highest PP range in the DCI bit scheme. The mobile UEs also refer to UE(s) not in a frequently paged cell in some embodiments of the present application. The mobile UEs also refer to UE(s) not in the last one or more used cell in some embodiments of the present application. The last used cell is the last cell where UE receives either RRC connection release message(s) or the RRC connection suspending message(s), or the last used cell is the last cell where UE has the CN connection. The mobile UEs can be grouped into different paging groups as non-mobile UEs as stated above, e.g., by a UE ID based grouping rule, a PP information based grouping rule, or the combination of UE ID based grouping rule and PP information based grouping rule etc. In addition, grouping rules for mobile UEs can be used independently or can be combined with other rules as stated above for UEs without considering the mobility.

FIG. 5 illustrates a scheme diagram of paging grouping for mobile UEs and non-mobile UEs in the DCI bit scheme according to some embodiments of the present application.

Referring to FIG. 5, there are 6 DCI bits, wherein DCI bits 1-4 are used for non-mobile UEs while DCI bits 5-6 are used for mobile UEs. Each DCI bit is associated with a paging group. For the non-mobile UEs, a combination rule with the paging probability information based grouping rule firstly (PP range 1 and PP range 2) and UE ID based grouping rule secondly is applied, and groups 1-4 are obtained. For the mobile UEs, a UE ID based grouping rule is used, and groups 5 and 6 are obtained. In some other embodiments, for the mobile UEs, a paging probability information based grouping rule is used, and groups 5 and 6 are obtained.

In some other embodiments of the present application, the network side may configure the paging grouping information to indicate the set of DCI bits for all UE(s) by bit map to enable or disable PDSCH decoding. For example, a set of DCI bits for paging may be configured as 00000, which means all the UEs do not need to decode the PDSCH; or a set of DCI bits for paging may be configured as 11111, which means all the UEs need to decode the PDSCH.

In some yet other embodiments of the present application, the network side may configure the paging grouping information to indicate mapping a set of paging group IDs for UEs without paging probability into part or all of the set of DCI bits, each DCI bit indicating a paging group ID. For example, when the PP is not configured for a UE while a PP information based grouping rule is applied, the UE may be grouped into a group with the highest group ID, which may be indicated by a DCI bit associated with the highest group ID, or may be associated with the highest PP, or may be associated with the highest PP threshold.

According to some embodiments of the present application, the paging group ID information is indicated via paging radio network temporary identity (P-RNTI) in the PDCCH, which is also referred to as “P-RNTI scheme” hereafter. According to some embodiments of the present application, the paging group ID information may include first paging group ID information indicated via at least one P-RNTI value. According to some embodiments of the present application, the paging group ID information may include first paging group ID information indicated via at least one P-RNTI value and second paging group ID information indicated via at least one set of DCI bits scrambled by the P-RNTI in the PDCCH. The number of P-RNTI values and the number of the at least one set of DCI bits can be configured in the network side.

In some embodiments of the present application, the at least one P-RNTI value indicates a number of at least one first paging group, and each of the at least one first paging group is associated with a corresponding set of the at least one set of DCI bits. The number of the at least one first paging group may be determined based on the number of the at least one P-RNTI value. The at least one first paging group may be obtained based on at least one of paging probability information and UE ID information. The P-RNTI value indicates a number of at least one first paging group, which indicates UE(s) to further decode the DCI bit to determine whether decode the PDSCH, or indicates UE(s) to further decode the PDSCH.

According to some embodiments of the present application, in the UE side, determining whether to decode PDSCH may include firstly determining whether to decode the at least one set of DCI bits based on the first paging group ID information. In response to a first paging group ID of the UE is indicated in the first paging group ID information, the UE will determine to decode the at least one set of DCI bits. Otherwise, in response to the first paging group ID is not indicated in the first paging group ID information, determining not to decode the at least one set of DCI bits. In response to decoding the at least one set of DCI bits, the UE may determine whether a second paging group ID is indicated in the second paging group ID information. Similarly, in response to the second paging group ID is indicated in the second paging group ID information, the UE will determine to decode the PDSCH. Otherwise, in response to the second paging group ID is not indicated in the second paging group ID information, the UE will determine not to decode the PDSCH. Besides, determining whether to decode PDSCH may include determining whether to decode the PDSCH based on the indication of the P-RNTI value.

According to some embodiments of the present application, UEs can be divided into at least one first paging group based on at least one of paging probability based grouping, UE-ID based grouping, UE mobility based grouping, or the combination of some of them. The number of the first paging groups, could be e.g., log 2(n), wherein n is the number of P-RNTI values configured by the network side. The paging group information on mapping of the first paging groups indicated by P-RNTI and paging probability information could be configured by the network side. The paging grouping information on the mapping of the first paging groups indicated by P-RNTI and the UE mobility information could be configured by the network side. Here, at least one first paging group may include all the UE paging groups which could be indicated by P-RNTI in the network side.

According to some embodiments of the present application, a plurality of DCI bits is also divided into at least one set of DCI bits based on the number of the UE group indicated by P-RNTI values. Each set of DCI bits can be associated with a second paging group based on various embodiments in DCI bit scheme, and thus will not be repeated. The ID of a second paging group for each set of DCI bits is equal to the value=F(UE-ID) mode the number of DCI bits belonged to this group associated to P-RNTI. According to some other embodiments of the present application, the ID of a second paging group for each set of DCI bits is computed based on the paging probability based grouping. The paging probability information related to a DCI bit in the set of DCI bits is configured by the network side or stored in the UE side. When the paging probability information related to a DCI bit in the set of DCI bits is stored in the UE side, the paging probability information related to a DCI bits in the set of DCI bits is an averaged range of the paging probability information to the set of DCI bits. For example, when the paging probability information to the set of DCI bits is from 0 to 0.6, and the number of DCI bits in the set of DCI bits is 3, the paging probability information for each bit in the set of DCI bits could be paging probability x is <=0.2, paging probability is 0.2<x<=0.4, and paging probability is 0.4<x<=0.6.

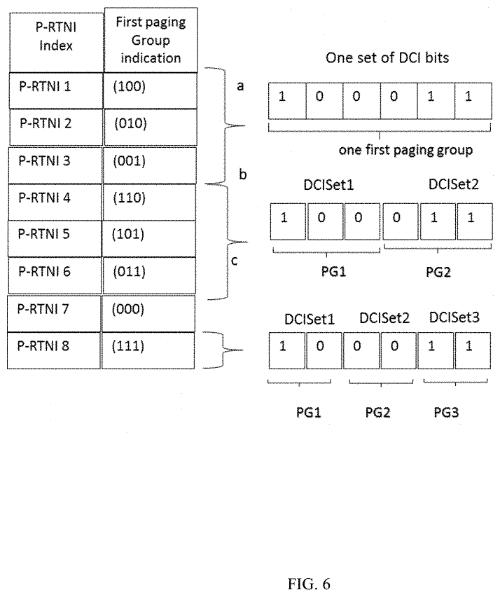

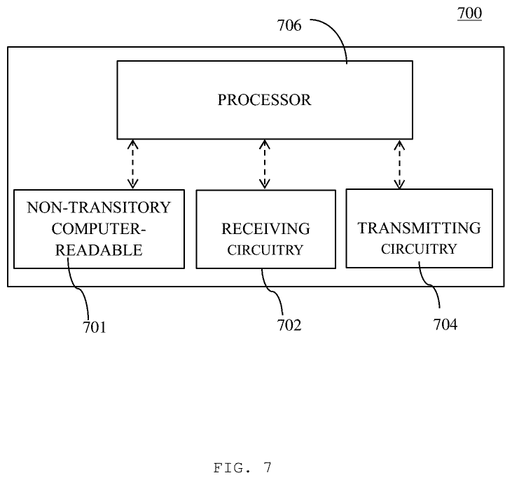

FIG. 6 illustrates a scheme diagram of paging grouping in the R-RNTI scheme according to some embodiments of the present application.

Referring to FIG. 6, eight P-RNTI values are configured for paging, and then UEs in a paging occasion (PO) can be divided into maximum 3 first paging groups. In some embodiments, the P-RNTI values may be 4, and the number of first paging groups is 2. In some other embodiments, the P-RNTI values may be 2, and the number of the first paging groups is 1.

Case a: when there is only one first paging group based on the number of P-RNTI value, such as being indicated as (100), (010), or (001), UEs in the indicated first paging group will share the total DCI bits for paging, e.g., 6 DCI bits. The second paging groups associated the 6 DCI bits can be further determined based on any rules used in the DCI bits scheme, wherein there is only one set of DCI bits including 6 DCI bits. In some other embodiments, the UEs in the indicated first paging group will share a number of total DCI bits for paging, and the number is configured by the network side.

Case b: when there are 2 first paging groups, e.g., PG1, PG2 based on the number of P-RNTI value, such as being indicated as (110), (011), (101), all UEs indicated in PG1 and PG2, or indicated in PG2 and PG3, or indicated in PG1 and PG3 will share the total DCI bits for paging, e.g., 6 DCI bits. For example, a first set of DCI bits, DCISet1, includes 3 DCI bits, and a second set of DCI bits, DCISet2 includes 3 DCI bits. The number of bits within each DCI set can be configured by in the network side, or be an averaged value which corresponds to the number of DCI bits for this paging group divided by the number of the first paging groups. The number of bits within each DCI bit set may be equal to the number=floor(the number of DCI bits for this paging group divided by the number of the first paging groups). When there is any reserved DCI bit based on this floor function, it could be allocated to one or more dedicate DCI bit set. The dedicate DCI bit set could be the last n number of bit DCI set, the first n number of DCI bit set, the DCI bit set with the lowest paging probability information, or the DCI bit set with highest paging probability information. The value of n could be configured by network. The number of n could be equal to the number of the reserved DCI bit. The reserved DCI bit in each dedicated DCI bit set could be same or not. The second paging groups associated each DCI bit set can be further determined based on any rules used in the DCI bits scheme, e.g., for by UE ID based grouping rule, or PP information based grouping rule, or a combination rule of UE ID based grouping rule with PP information based grouping rule etc.

Case c: when there are 3 first paging groups, e.g., PG1, PG2, PG3 based on the number of P-RNTI value, such as being indicated as (111), all UEs indicated in PG1, PG2 and PG3 will share the total DCI bits for paging, e.g., 6 DCI bits. For example, a first set of DCI bits, DCISet1, includes 2 DCI bits, a second set of DCI bits, DCISet2 includes 2 DCI bits, and a third set of DCI bits, DCISet3 includes 2 DCI bits. The number of bits within each DCI set can be configured by in the network side. The number of bits within each DCI bit set can be configured by the network side, or be an averaged value which corresponds to the number of DCI bits for this paging group divided by the number of the first paging groups. The number of bits within each DCI bit set may be equal to a number calculated by floor(the number of DCI bits for this paging group divided by the number of the first paging groups). When there is any reserved DCI bit based on this floor function, it could be allocated to one or more dedicate DCI bit set. The dedicate bit DCI set could be the last n number of DCI bit set, the first n number of DCI bit set, the DCI bit set with the lowest paging probability information, or the DCI bit set with highest paging probability information. The value of n could be configured by network. The number of n could be equal to the number of the reserved DCI bit. The reserved DCI bit in each dedicated DCI bit set could be same or not. The second paging groups associated each DCI bit set can be further determined based on any rules used in the DCI bit scheme, e.g., for by a UE ID based grouping rule, or a PP information based grouping rule, or a combination rule of the UE ID based grouping rule with the PP information based grouping rule etc. The second paging groups associated each DCI bit set can be further determined based on any rules used in the DCI bits scheme, e.g., for by UE ID based grouping rule, or PP information based grouping rule, or a combination rule of UE ID based grouping rule with PP information based grouping rule etc.

Since there are first grouping stage and second paging grouping stage depending on the first grouping stage (e.g., above combination of rules in DCI bit scheme or P-RNTI scheme etc.), the resulted paging groups can also be referred to as a two-level group structure. The paging grouping information and paging group ID information should ensure a UE to proper firstly obtain the indicated first paging group and then obtain the indicated second paging group based on the obtained paging group. For a two-level group structure, the first paging group can also be referred to as a paging group set and the second paging group can also be referred to as a paging group within the paging group set; or the first paging group can also be referred to as a paging group and the second paging group can also be referred to as a paging sub-group within the paging group. In some other embodiments, the name of group in each level in the two-level structure group structure can be named in other manners.

An exemplary procedure for decoding a two-level structure group is illustrated as follows, which is also adaptive to other two-level group structures.

Paging group set selection: Table 1 is related to paging group set definition when a parameter probThreshList is configured in the network side. The parameter probThreshList could be included in paging grouping information. A plurality of paging groups are first assigned to paging group set 1, followed by paging group set 2, and so on. After receiving probThreshList, a UE will determine (or select) the paging group sets as defined in Table 1. The total number of paging group sets is equal to: the number of entries in probThreshList+1. The UE determines the paging group set corresponding to its paging probability PPG, if being configured as defined in Table 1; while if PPG is not configured, the UE selects the paging group set with the highest index.

TABLE 1

| paging | | paging group index | |
|---|---|---|---|
| group | | in paging groups list | |
| set | probThreshList | Lower bound | Upper bound |
| 1 | P_{PG} ≤ Thresh₁ | 0 | Nₜₕ₁ − 1 |
| 2 | Thresh₁ < P_{PG} ≤ Thresh₂ | Nₜₕ₁ | Nₜₕ₁ + Nₜₕ₂ − 1 |
| | (Note) | | |
| 3 | Thresh₂ < P_{PG} ≤ Thresh₃ | Nₜₕ₁ + Nₜₕ₂ | Nₜₕ₁ + Nₜₕ₂ + |
| | (Note) | | Nₜₕ₃ − 1 |
| 4 | P_{PG} > Thresh₃ | Nₜₕ₁ + Nₜₕ₂ + Nₜₕ₃ | maxPG-1 |

where
Threshᵢ is the value signalled in the i^{th} entry of probThreshList
Nₜₕᵢ is the value signalled in the i^{th} entry of groupsForServiceList
(Note):
When the total number of paging group sets is less than 4, the upper bound for the paging group set with highest index is maxPG-1.

In some embodiments of the present application, the network side may not configure probThreshList or the UE does not receive probThreshList. For the UE, there is only one paging group set containing all the paging groups configured. The total number of paging groups is maxPG.

Paging group selection: After determining or selecting the paging group set as stated above, the UE will selects the paging group to monitor below.

For bandwidth reduced low complexity (BL)UE or UE in enhanced coverage, the UE determines a paging group, PG, with the following equation (1):

$$PG = floor ( floor ( \frac{UE\_ID}{N \times {N}_{s}} ) / {N}_{n} ) mod {N}_{w} \qquad ( 1 )$$

For NB-IoT, the UE determines PG with following equation (2):

$$PG = floor ( \frac{UE\_ID}{N \times {N}_{s} \times W} ) mod {N}_{w} \qquad ( 2 )$$

Or the UE determines PG with the following equation (3):

$$PG = floor ( \frac{UE\_ID}{N \times {N}_{s}} ) mod {N}_{w} \qquad ( 3 )$$

where:
UE_ID, N, Nₛ, Nₙ and W are defined as follows:
N_{w} is the number of DCI bits in the selected group set based on paging probability based grouping.
T: discontinuous reception (DRX) cycle of the UE. (T is determined by the shortest of the UE specific DRX value(s), if configured by radio resource control (RRC) and/or upper layers, and a default DRX value broadcast in system information. In RRC_IDLE state, if UE specific DRX is not configured by upper layers, the default value is applied).
N: number of total paging frames in T
Ns: number of paging occasions for a PF (Paging Frame)
PF_offset: offset used for PF determination
UE_ID: 5G-S-Temporary Mobile Subscriber Identity (5G-S-TMSI)( )mod 1024.
PG is the index of the paging group in the selected paging group set. It is from 0 . . . N_{W}−1.

5G-S-TMSI is a bit string with 48 bits. 5G-S-TMSI in the formulae above shall be interpreted as a binary number where the left most bit represents the most significant bit. When the UE has no 5G-S-TMSI, for instance when the UE has not yet registered onto the network, the UE shall use as default identity UE_ID=0 in the PF and i_s formulas above.

Table 2 is related to the index of the paging group to monitor. For the UE, it will determine PG, the index of the corresponding paging group, PGI within the paging groups list, as defined in Table 2. In some embodiments of the present application, the network side may not configure probThreshList or the UE does not receive probThreshList. For the UE, it will consider PG as PGI to monitor. The entries corresponding to PG in the paging groups list are defined by the network side. Here, the group for service means the group based on paging probability information grouping.

TABLE 2

| paging group set | PGI |
|---|---|
| 1 | PG |
| 2 | PG + Nₜₕ₁ |
| 3 | PG + Nₜₕ₁ + Nₜₕ₂ |
| 4 | PG + Nₜₕ₁ + Nₜₕ₂ + Nₜₕ₃ |

Where Nₜₕᵢ is defined in above table 1.

According to some other embodiments of the present application, a particular RS can be introduced for paging.

In some embodiments of the present application, at least one UE group associated with at least one paging group (or the second paging group in PRNTI scheme) indicated by a set of DCI bits in DCI bit scheme. UE will determine whether to decode the PDCCH based on the received RS. Decoding PDCCH or PDCCH decoding in some embodiments of the present application includes blind search and decoding. For example, a first RS is associated with UE groups (1 . . . n), and a second RS is associated with UE groups (n+1 M). When a UE belongs to UE groups (1 . . . n) detects the first RS, it will decode the PDCCH following the first RS. Then, the UE will determine whether to decode PDSCH based on a DCI bits scheme or a P-RNTI scheme etc. paging grouping schemes. When a UE belonging to UE groups (n+1 . . . M) does not detect the second RS, it will skip the PDCCH following the second RS and will not decode the PDCCH.

In another example, in view of the P-RNTI scheme, a first RS is associated with at least one paging group indicated by only P-RNTI, or both P-RNTI and DCI bits, while a second RS is associated with at least one other paging groups indicated by only P-RNTI, or both P-RNTI and DCI bits. When the UE belonging to the paging group is not indicated by the first RS, the UE will skip the PDCCH decoding. Otherwise, the UE will continue to perform the PDCCH decoding to determine whether it needs to decode the PDSCH when it receives the P-RNTI, or the P-RNTI and its related DCI bits.

In some other embodiments of the present application, the RS can be applied for paging group independently. For example, a RS indicating at least one paging groups can be configured in the network side and transmitted to the UE. After receiving the RS, the UE will determine to decode the PDSCH when its paging group ID is indicated in the RS. Otherwise, the UE will determine not to decode the PDSCH when its paging group ID is not indicated in the RS.

The mapping information of RS and the paging group could be configured by the network side or stored in the UE side. The UE will obtain its RS information related to its UE group information based on the mapping information.

Embodiments of the present application also propose an apparatus for paging. For example, FIG. 7 illustrates a block diagram of an apparatus 700 for paging according to some embodiments of the present application.

As shown in FIG. 7, the apparatus 700 may include at least one non-transitory computer-readable medium 701, at least one receiving circuitry 702, at least one transmitting circuitry 704, and at least one processor 706 coupled to the non-transitory computer-readable medium 701, the receiving circuitry 702 and the transmitting circuitry 704. The apparatus 700 may be a network side apparatus (e.g., a B S) configured to perform a method illustrated in FIG. 2 and the like, or a remote unit (e.g., a UE) configured to perform a method illustrated in FIG. 2 or the like.

Although in this figure, elements such as the at least one processor 706, transmitting circuitry 704, and receiving circuitry 702 are described in the singular, the plural is contemplated unless a limitation to the singular is explicitly stated. In some embodiments of the present application, the receiving circuitry 702 and the transmitting circuitry 704 can be combined into a single device, such as a transceiver. In certain embodiments of the present application, the apparatus 700 may further include an input device, a memory, and/or other components.

For example, in some embodiments of the present application, the non-transitory computer-readable medium 701 may have stored thereon computer-executable instructions to cause a processor to implement the method with respect to the UE as described above. For example, the computer-executable instructions, when executed, cause the processor 706 interacting with receiving circuitry 702 and transmitting circuitry 704, so as to perform the steps with respect to the UE depicted in FIG. 2.

In some embodiments of the present application, the non-transitory computer-readable medium 701 may have stored thereon computer-executable instructions to cause a processor to implement the method with respect to the BS as described above. For example, the computer-executable instructions, when executed, cause the processor 706 interacting with receiving circuitry 702 and transmitting circuitry 704, so as to perform the steps with respect to the BS depicted in FIG. 2.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus including a processor and a memory. Computer programmable instructions for implementing a method stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A method, comprising:
receiving paging grouping information associated with physical downlink control channel (PDCCH);
receiving paging group identity (ID) information indicated in the PDCCH; and
determining whether to decode physical downlink shared channel (PDSCH) based on the paging grouping information and the paging group ID information.

2. (canceled)

3. The method of claim 1, comprising:
determining whether a paging group ID of a user equipment (UE) is indicated in the paging grouping information;
in response to determining that the paging group ID is not indicated in the paging group ID information, determining not to decode the PDSCH; and
in response to determining that the paging group ID is indicated in the paging group ID information, determining to decode the PDSCH.

4. The method of claim 1, wherein: the paging group ID information is indicated via a set of downlink control information (DCI) bits in the PDCCH; and the paging grouping information indicates mapping a set of paging group IDs into the set of DCI bits based on performing paging probability based grouping first and then performing user equipment (UE) ID based grouping, each bit of the first set of DCI bits being associated with a paging group ID.

5. The method of claim 4, wherein mapping a set of paging group IDs into the set of DCI bits based on performing paging probability based grouping first and then UE ID based grouping comprises:
dividing the set of DCI bits into at least one sub-set of DCI bits based on at least one paging probability threshold;
associating each sub-set of DCI bits with a corresponding paging probability range determined based on the at least one paging probability threshold;
dividing a plurality of UEs into at least one UE group associated with a corresponding paging probability range based on respective paging probability of the plurality of UEs; and
dividing UE(s) within each UE group into at least one UE sub-group based on respective UE ID of the UE(s), wherein each UE sub-group corresponds to a paging group.

6.-30. (canceled)

31. The method of claim 1, further comprising:
receiving a reference signal (RS) indicating at least one paging groups;
in response to a paging group ID not being indicated in the RS, determining not to decode the PDSCH; and
in response to a paging group ID not being indicated in the RS, determining to decode the PDSCH.

32. (canceled)

33.-62. (canceled)

63. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
receive paging grouping information associated with physical downlink control channel (PDCCH);
receive paging group identity (ID) information indicated in the PDCCH; and
determine whether to decode physical downlink shared channel (PDSCH) based on the paging grouping information and the paging group ID information.

64. (canceled)

65. The apparatus of claim 63, wherein the computer-executable instructions cause the at least one processor to:
determine whether a paging group ID of a user equipment (UE) is indicated in the paging grouping information;
in response to determining that the paging group ID is not indicated in the paging group ID information, determine not to decode the PDSCH; and
in response to determining that the paging group ID is indicated in the paging group ID information, determine to decode the PDSCH.

66. The apparatus of claim 63, wherein: the paging group ID information is indicated via a set of downlink control information (DCI) bits in the PDCCH; and the paging grouping information indicates mapping a set of paging group IDs into the set of DCI bits based on performing paging probability based grouping and then performing user equipment (UE) ID based grouping, each bit of the first set of DCI bits being associated with a paging group ID.

67. The apparatus of claim 66, wherein to map a set of paging group IDs into the set of DCI bits based on performing paging probability based grouping and then UE ID based grouping, the at least one processor:
divides the set of DCI bits into at least one sub-set of DCI bits based on at least one paging probability threshold;
associates each sub-set of DCI bits with a corresponding paging probability range determined based on the at least one paging probability threshold;
divides a plurality of UEs into at least one UE group associated with a corresponding paging probability range based on respective paging probability of the plurality of UEs; and
divides UE(s) within each UE group into at least one UE sub-group based on respective UE ID of the UE(s), wherein each UE sub-group corresponds to a paging group.

68. The apparatus of claim 63, wherein: the paging group ID information is indicated via a set of downlink control information (DCI) bits in the PDCCH; and the paging grouping information indicates mapping a set of paging group IDs into the set of DCI bits based on paging probability based grouping, each bit of the set of DCI bits being associated with a paging group ID.

69. The apparatus of claim 63, wherein: the paging group ID information is indicated via a set of downlink control information (DCI) bits in the PDCCH; and the paging grouping information indicates mapping a set of paging group IDs for mobile UEs into the set of DCI bits, each bit of the set of DCI bits being associated with a paging group ID.

70. The apparatus of claim 1, wherein the paging group ID information comprises first paging group ID information indicated via at least one paging radio network temporary identity (P-RNTI) value and second paging group ID information indicated via at least one set of DCI bits scrambled by the P-RNTI in the PDCCH.

71. The apparatus of claim 1, wherein the computer-executable instructions cause the at least one processor to:
receive a reference signal (RS) indicating at least one paging groups;
in response to a paging group ID not being indicated in the RS, determine not to decode the PDSCH; and
in response to a paging group ID not being indicated in the RS, determine to decode the PDSCH.

72. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to:
transmit paging grouping information associated with physical downlink control channel (PDCCH); and
transmit paging group identity (ID) information indicated in the PDCCH, to enable a determination of whether to decode physical downlink shared channel (PDSCH) based on the paging grouping information and the paging group ID information.

73. The apparatus of claim 72, wherein the paging group ID information is indicated via a set of downlink control information (DCI) bits in the PDCCH.

74. The apparatus of claim 73, wherein the paging grouping information indicates mapping a set of paging group IDs into the set of DCI bits based on performing paging probability based grouping and then performing user equipment (UE) ID based grouping, each bit of the first set of DCI bits being associated with a paging group ID.

75. The apparatus of claim 74, wherein to map a set of paging group IDs into the set of DCI bits based on performing paging probability based grouping then UE ID based grouping, the at least one processor:
divides the set of DCI bits into at least one sub-set of DCI bits based on at least one paging probability threshold;
associates each sub-set of DCI bits with a corresponding paging probability range determined based on the at least one paging probability threshold;
divides a plurality of UEs into at least one UE group associated with a corresponding paging probability range based on respective paging probability of the plurality of UEs; and
divides UE(s) within each UE group into at least one UE sub-group based on respective UE ID of the UE(s), wherein each UE sub-group corresponds to a paging group.

76. The apparatus of claim 73, wherein the paging grouping information indicates mapping a set of paging group IDs into the set of DCI bits based on paging probability based grouping, each bit of the set of DCI bits being associated with a paging group ID.

77. The apparatus of claim 76, wherein to map a set of paging group IDs into the set of DCI bits based on paging probability based grouping, the at least one processor:
determines a corresponding paging probability range associated with each bit of the set of DCI bits; and
divides a plurality of user equipment (UE)s into the at least one paging group based on respective paging probability of the plurality of UEs.

78. The apparatus of claim 72, wherein the paging group ID information comprises first paging group ID information indicated via at least one paging radio network temporary identity (P-RNTI) value and second paging group ID information indicated via at least one set of downlink control information (DCI) bits scrambled by the P-RNTI in the PDCCH.
